(19) United States
(12) Patent Application Publication
(10) Pub. No.: US 2026/0217231 A1
(43) Pub. Date: Jul. 30, 2026

(54) METHOD FOR OPERATING A BRAKE SYSTEM WITH INCREASED SAFETY IN THE FALLBACK LEVEL AND BRAKE SYSTEM WITH INCREASED SAFETY IN THE FALLBACK LEVEL

(71) Applicant: Continental Automotive Technologies GmbH, Hannover (DE)

(72) Inventors: Thorsten Ullrich, Gernsheim (DE); Martin Baechle, Kõnigstein (DE); Tobias Scheller, Hofbieber (DE)

(73) Assignee: Continental Automotive Technologies GmbH, Hannover (DE)

(21) Appl. No.: 19/147,312

(22) PCT Filed: Dec. 21, 2023
(86) PCT No.: PCT/DE2023/200266

§ 371 Date: Jul. 10, 2025

(30) Foreign Application Priority Data
Jan. 11, 2023 (DE) 10 2023 200 166.7

(51) Int. Cl. B60T 13/66; B60T 7/04; B60T 8/88; B60T 17/22

(52) U.S. Cl. CPC B60T 13/662; B60T 7/042; B60T 8/885; B60T 17/22; B60T 2270/402

(57) ABSTRACT

The embodiments generally relate to a method for operating a brake system with increased safety in the fallback level, and to such a brake system for a motor vehicle. Here, the brake system may comprise a brake system which requires no operating fluids. Here, the method for operating the brake system provides for actuating wheel brake modules of the motor vehicle in a normal operating level by a central control electronics unit, and for actuating the wheel brake modules in a fallback level, wherein the fallback level is designed in a two-circuit manner.

### TECHNICAL FIELD

The embodiments generally relate to a method for operating a brake system with increased safety in the fallback level, and to such a brake system for a motor vehicle.

### BACKGROUND

In automotive technology, “brake-by-wire” brake systems are being used ever more widely. This refers to brake systems that can be operated without operating fluids, such as brake fluid.

Such brake systems can comprise an electric brake pedal (often referred to as an e-pedal). Here, the wheel brakes can be designed as electromechanical (dry) brakes. The brake pedal is configured to detect a driver's brake request or a brake demand using a sensor and to generate a corresponding actuating signal from it.

The detected brake request can be used to determine a setpoint brake torque or a setpoint brake pressure for the wheel brakes. To this end, the driver's brake request signal can be transmitted to a central control unit which performs the electric actuation of the wheel brakes.

In such brake systems, the driver is decoupled from direct access to the wheel brakes, since the actuation takes place solely electrically or electronically by means of corresponding control devices.

It is therefore a difficulty in such brake systems that the possibility of providing driver intervention by way of a mechanical and/or hydraulic action, which is brought to effect in the event of failure of the electronic control device, is dispensed with. Such methods are known under the term “hydraulic fallback level”. Secondly, it is necessary that, in the event of a failure of a control device, it is possible to switch into a fallback level in order to be able to maintain essential functions of the brake system.

This can result in the entire control path from pedal actuation to application of the brake force being carried out with at least one layer of redundancy, in order that, in the event of an individual fault, the wheel brakes cannot fail or the minimum brake effect prescribed by law cannot be undershot.

In this sense, redundancy means the additional provision of functionally identical or comparable components, parts or systems; that is to say, for example, at least the double provision of connections, for example data lines, or else at least the double provision of corresponding control devices. In this way, safe operation of the brake system as a whole can still be ensured in the event of failure of a component, a part or a system. This does not affect the fact that certain functions, for example auxiliary functions which are used for comfort, can also be dispensed with in the redundancy level and only the basic functions are replicated identically or comparably.

Therefore, known approaches of architectures of brake systems may have a redundancy level, with the result that, for example, when a primary control device (“ECU”) of the primary control functions (“Veh Primary”) is switched off, another control device or level is still available (“Veh Secondary”), which then takes over the control, if necessary even to a reduced extent.

With such architectures, however, it is necessary that this fallback path which is present only in a single layer must already be completely error-free.

A brake system is therefore desirable which firstly meets the applicable safety demands, even with regard to possible driverless driving, and which secondly also offers increased safety in relation to the fallback level.

It would be useful here if a test operation can also be made possible, in which, for example, a primary control device can be switched off specifically in order to test the functionality in the fallback level, for instance.

### SUMMARY

This object is achieved by a method for operating a brake system, for example for a motor vehicle, and a correspondingly designed brake system.

A first aspect of a method for operating a brake system, for a motor vehicle, with for example four electrically actuable wheel brake modules which can be homogeneously assigned to two different axles of the motor vehicle, with the following steps:
determining actuating information describing a brake demand by a brake actuating unit, wherein the brake demand can preferably be detected by at least one first pedal sensor or front axle (FA) pedal sensor and one second pedal sensor or rear axle (RA0 pedal sensor independently of each other,
generating brake torque demands RQT_FA*, RQT_RA* corresponding to the actuating information by means of a central control electronics unit,
generating brake torque demands RQT_FA corresponding to the actuating information by at least one FA brake control unit which is assigned to the wheel brake modules of a front axle, or which is assigned to two diagonally arranged wheel brake modules,
generating brake torque demands RQT_RA corresponding to the actuating information by at least one RA brake control unit which is assigned to the wheel brake modules of a rear axle, or which is assigned to the two other diagonally arranged wheel brake modules,
actuating the wheel brake modules of the brake system according to a normal operating level with the brake torque demands RQT_FA*, RQT_RA*, or
actuating the wheel brake modules assigned to the FA brake control unit according to a fallback level with the brake torque demand RQT_FA, and/or actuating the wheel brake modules assigned to the RA brake control unit according to the fallback level with the brake torque demand RQT_RA.

In a first aspect, a method for operating a brake system comprises a two-circuit fallback path. The brake system can be designed, for example, for or as part of a service brake.

In a further aspect, different architectures of brake systems are proposed purely by way of example, which have such a two-circuit fallback path and which are suitable for carrying out the abovementioned method for operating a brake system. These brake system architectures are discussed in more detail below.

A motor vehicle may refer to a vehicle that has axles, wherein at least one of these axles comprises steerably guided wheels and, furthermore, the drive of the wheels of at least one axle is adaptable in a wheel-specific manner.

Here, the brake system can comprise electromechanical wheel brakes (also designated as EMB=electromechanical brake), wherein for example all wheel brakes of the motor vehicle can be designed as electromechanical or electrically actuable wheel brakes. Each wheel brake can be assigned to one wheel brake module.

Here, the electromechanical wheel brakes can be embodied as electromechanical disk brakes, in which a brake application force can be produced by means of an electric motor, a primary gear unit and a rotation-translation mechanism. Here, the brake application force means the force with which the brake linings are pressed against the brake disk. During operation, a corresponding brake torque is then produced in this way at the wheel under consideration. Depending on the embodiment and control concept, the actuation can be selected in such a way that either a specified, defined clamping force or a specified, defined brake torque is set in accordance with the demanded deceleration request.

The electromechanical wheel brakes can also be designed as an electromechanical drum brake, in which the motor/gear unit actuates an expansion module which presses the brake linings against the brake drum with an expansion force determined on the basis of the demanded deceleration request and thus produces a corresponding brake torque. Depending on the embodiment and control concept, the actuation can be embodied in such a way that a defined expansion force or a defined brake torque is set in accordance with the deceleration request.

In the case of the brake system, for example, the two brakes assigned to the front axle can be embodied as electromechanical disk brakes and the two brakes assigned to the rear axle can be embodied as electromechanical drum brakes. However, all of the brakes can also be embodied as electromechanical disk brakes or electromechanical drum brakes.

According to one development, it is also possible and envisaged to use the brake system together with hydraulically actuable wheel brakes, for instance in the fallback level.

The method provides that, in addition to a central brake control unit (hereinafter referred to as a central control electronics unit), a fallback level is provided which can be divided into two parts.

In the brake system, a brake actuating unit can be provided to this end, which is configured for detecting a driver's brake request and for determining corresponding actuating information which corresponds to the brake demands of the driver.

Within the meaning, the actuating information can be detected by at least one first and one second sensor or pedal sensor (hereinafter referred to as FA pedal sensor and RA pedal sensor independently of one another, wherein the pedal sensors can be combined in the brake actuating unit. For example, the same brake demand is detected by the two pedal sensors independently of each other, with the result that there is complete redundancy in the detection of a brake demand of the driver.

According to embodiments, the at least two pedal sensors can be based on the same measuring principle, but also on different measuring principles. In one embodiment, the two pedal sensors each comprise at least two different measuring principles, for example a force sensor, which detects the force with which the driver steps on the pedal, and a displacement sensor, which measures the distance over which the driver depresses the pedal. In the case of these different pedal sensors, the fault patterns are different, with the result that a jammed pedal, for example, can be detected from the fact that force is exerted on the pedal without the latter moving.

The central control electronics unit can be configured to generate the brake torque demand based on the actuating information on the basis of stored control algorithms. The brake torque demand can be axle-specific, but also wheel-specific here. Axle-specific brake torque demands are also referred to below as RQT_FA* for the front axle and RQT_RA* for the rear axle. Corresponding wheel-specific brake commands RQT_xA* can be generated from these brake torque demands, by way of which, for example, actuators of the wheel brakes can be actuated and operated.

According to one embodiment, it is also provided that the central control electronics unit already generates wheel-specific brake commands RQT_xA*.

The wheel brakes can be part of the electrically actuable wheel brake module which can comprise further components, such as a control device close to the wheel (“WCU”). Here, the brake system may comprise at least two such wheel brake modules assigned to one axle, wherein the two axles e.g. all axles of the motor vehicle can each comprise two such wheel brake modules. The wheel brake modules can be designed to be electrically actuable here.

The wheel brake modules can also be configured to actuate the wheel brakes, for example actuators of the wheel brake, in accordance with the brake torque demands, i.e. to load the actuators with appropriate electrical voltage, for example. The conversion of the brake torque demands into corresponding wheel-specific brake commands, for example specified values for the specific voltage application, can be carried out, for example, by means of the control devices close to the wheel.

However, it is also possible to combine these control devices for the wheel brakes of one axle and to provide them as a so-called axle controller. According to one embodiment, two such axle controllers are provided.

The division according of the fallback level in two can be achieved in that in each case at least one brake control unit is assigned to at least each axle of the motor vehicle which is equipped with wheel brake modules. Accordingly, at least one brake control unit (hereinafter referred to as FA brake control unit) can be assigned to the front axle, and a further brake control unit (hereinafter referred to as RA brake control unit) can be assigned to the rear axle.

The FA brake control unit and the RA brake control unit can be configured to likewise generate brake torque demands based on the actuating information of the brake actuating unit on the basis of stored control algorithms. These brake torque demands (hereinafter referred to as RQT_FA for the front axle and RQT_RA for the rear axle) can accordingly likewise be axle-specific. According to one embodiment, it is also provided that the brake control units can already generate wheel-specific brake commands RQT_xA.

The brake actuating unit, for example the at least two pedal sensors, can be connected to the brake control units electrically or in terms of signals to this end, with the result that actuating information can be transmitted directly to the brake control units. The actuating information may be transmitted as digital signals, wherein corresponding converter components, e.g. A/D converters, can be provided for data conversion.

According to one embodiment, the FA pedal sensor can be connected to the FA brake control unit and the RA pedal sensor can be connected to the RA brake control unit. The actuating information can accordingly be detected independently of each other, and can be transmitted independently of each other to the respective brake control units. In this way, redundancy can be ensured with regard to the detection of the brake demand.

The brake control units can also be connected in signal terms to the central control electronics unit. In this way, the actuating information can be transmitted from the pedal sensors to the central control electronics unit via the brake control units.

Accordingly, at least one central control electronics unit for the central generation of brake torque demands and at least two brake control units each assigned to an axle of the motor vehicle can be provided for the independent generation of brake torque demands. In this way, the fallback level can be split in two and divided between the two axles.

In the embodiment described above, the brake control units are assigned to the wheel brake modules of the two different axles of the motor vehicle, that is to say two wheel brake modules of the front axle and two wheel brake modules of the rear axle, with the result that the wheel brakes assigned to the two axles can each be actuated independently of each other by the brake control units in the fallback level by the two pedal sensors.

According to a further embodiment, however, two brake control units can also be provided which can each actuate two wheel brake modules of different axles, and wherein these two wheel brake modules can be arranged for example diagonally in each case. Accordingly, the first pedal sensor or the FA pedal sensor can be connected in signal terms to a first brake control unit or the FA brake control unit which can be connected in signal terms to two diagonally opposite wheel brake modules, and the second pedal sensor or the RA pedal sensor can be connected to a second brake control unit or the RA brake control unit which can be connected to the two remaining opposite wheel brake modules. For example, the FA brake control unit can be designed to actuate the two wheel brake modules VL (front left) and HR (rear right), and the second RA brake control unit can be designed to actuate the two remaining wheel brake modules VR (front right) and HL (rear left). In this way, a two-circuit fallback path can also be realized.

The method can accordingly comprise the following steps:
generating brake torque demands (RQT_FA) corresponding to the actuating information by at least the first brake control unit or the FA brake control unit which is assigned to two wheel brake modules of a first axle or two wheel brake modules which are arranged diagonally opposite on two different axles, and
generating brake torque demands (RQT_RA) corresponding to the actuating information by at least the second brake control unit or the RA brake control unit which is assigned to two wheel brake modules of a second axle or the two remaining diagonally arranged wheel brake modules.

In a manner, the axle-related division with an FA brake control unit as the first brake control unit and an RA brake control unit as the second brake control unit is explained below, wherein these remarks may also intended to apply to two brake control units in the case of which the assignment and connection in signal terms of the brake control units to the wheel brake modules can be carried out diagonally as described above.

This makes it possible that, in the event of a lack of brake torque demands of the central control electronics unit, for example due to a failure, a defect or even shutdown of the central control electronics unit, the brake system can switch back to two separate control paths operating independently of each other in the fallback level. In such a case, the driver's brake demand detected at the brake pedal can lead to a brake torque demand RQT_FA for the vehicle wheels of the front axle and its implementation at the assigned wheel brake modules, and, independently of this, the separately detected brake demand results in a brake torque demand RQT_RA for the vehicle wheels of the rear axle and its implementation at the assigned wheel brake modules.

The embodiment thus affords that, additionally also with regard to possible driverless driving, the fallback level offers safety, since it creates further redundancy as a result of the division in two.

The method provides in the absence of brake torque demands from the central control electronics unit, for example as a result of an emergency stop or shutdown, only the higher-order control functions are switched off and the brake system can fall back to a safe two-circuit basic brake with basic function and slip control.

Thus, for example, a test operation can also be enabled and supported in which, for example, the central control electronics unit can be switched off in a targeted manner in order to test the functionality in the fallback level, for instance.

For the connection in signal terms between the pedal sensors and the brake control units, the brake system in one embodiment can comprise at least one first brake request signal line between the FA pedal sensor and the FA brake control unit and at least one second brake request signal line between the RA pedal sensor and the RA brake control unit. For further increased operational safety, one or both brake request signal lines can also be designed in a double, i.e. redundant, manner.

Furthermore, at least one data line can be provided between the at least one central control electronics unit and the FA brake control unit and at least one data line can be provided between the at least one central control electronics unit and the RA brake control unit. For further operational safety, these data lines can also be designed in a double, i.e. redundant, manner.

In summary, the method can provide an at least partial actuation of the wheel brake modules in a normal operating level or in a fallback level.

A normal operating level refers here to a mode of operation of the brake system in which at least the essential components of the brake system operate without faults and/or are fully or at least sufficiently functional. In other words, in the normal operating level, the components required for the brake system perform their intended functions. The normal operating level is therefore the typically provided or preset operating mode of the brake system. In this case, higher-order control functions can be implemented by the central control electronics unit. In the normal operating level, not only the basic functions, but other functions, such as ESP, ESC or standstill functions, can accordingly be provided.

The fallback level can be selected if the normal operating level is not available without faults or correctly, i.e. if, for example, essential components do not operate without faults. In the fallback level, a minimum brake effect can be achieved, wherein substantially at least the basic functions of the brake or service brake can still be carried out. The basic function of the brake can also comprise slip control (ABS).

In the normal operating level, the driver's brake request can be provided to the central control electronics unit in a redundant manner via the pedal sensors and the brake control units. This can determine the requested brake torque demands for the wheel brake modules or the wheel brakes under arbitration of all control functions, and can transmit them to the brake control units for actuation. In the fallback level, the driver's brake request is still available to the axle-specific brake control units via two channels, each with its own operating mode independent of the other axle. Here, communication to the outside can be completely dispensed with in an advantageous manner in this fallback level. For example, a basic brake function can be available in the fallback level, and optionally ABS (slip control) can be separated locally for each axle.

To this end, the wheel brake module can comprise further devices and components, for example wheel speed sensors. They can be connected to the brake control units in a known manner. This can prevent unwanted destabilization.

According to one embodiment, the decision logic means for the mode of operation of the brake system can be integrated into the brake control units, that is to say into the FA brake control unit and/or the RA brake control unit. The brake control units can comprise corresponding control functions or algorithms to this end. Starting from the normal operating level as the preferred mode of operation of the brake system, the method provides for switching over to the fallback level if the normal operating level is not available or is available only with impaired functional scope.

Here, the method can provide for actuating of the wheel brake modules in the normal operating level if
brake torque demands RQT_FA* and RQT_RA* exist and actuating information of at least one FA and/or RA pedal sensor is available, and if
there is no error message from the central control electronics unit, and if
the brake torque demands RQT_FA* and RQT_RA* do not exceed a predefined offset from the corresponding brake torque demands RQT_FA and RQT_RA.

If, during the operation of the motor vehicle or the brake system, actuating information describing the brake demand is present, i.e. a driver specifies a brake request by pedal pressure, the brake torque demands RQT_FA* and RQT_RA* of the central control electronics unit are initially used to actuate the wheel brake modules.

The brake control units can be used to check whether there is an error message from the central control electronics unit. An error message can be generated by the central control electronics unit, for example, if input data is missing or incomplete, or else if a lack of plausibility is determined by the stored algorithms. If there is an error message, the brake control units switch to the fallback level.

The brake control units can also be used to check whether the brake torque demands RQT_FA* and RQT_RA* of the central control electronics unit do not deviate or do not deviate significantly from the corresponding brake torque demands RQT_FA and RQT_RA which are generated by the brake control units themselves. In other words, the brake torque demands generated by the central control electronics unit and the brake control units themselves can be compared with one another.

If the brake torque demands RQT_FA* and RQT_RA* generated by the central control electronics unit do not deviate by a predefined value from the brake torque demands RQT_FA and RQT_RA generated by the brake control units themselves here, the brake torque demands RQT_FA* and RQT_RA* can be passed on to the respective wheel brakes in accordance with the normal operating level.

This predefined offset therefore represents a threshold. As a result, it is possible to prevent “underbraking” by the central control electronics unit and to install a so-called “safety barrier” against too little braking. The predefined value for the offset or the “safety barrier” can be defined in a customer-specific manner and stored in the brake control units.

For example, the threshold can be rather high, for example 0.5 g/1 g of brake torque, which means that, in the absence of a brake torque demand RQT_FA* and RQT_RA* of the central control electronics unit, the driver must increase the pressure on the brake pedal of the brake actuating unit by 0.5 g/1 g of brake torque accordingly. In this way, a higher difference, provided for system-related reasons, between the values of the brake torque demands RQT_FA and RQT_RA and the brake torque demands RQT_FA* and RQT_RA*, which can be used, for example, to enable recuperation, can be stored.

Recuperation or regenerative braking via the drive can be specified by the central control electronics unit, which leads to the brake torque demands RQT_FA* and RQT_RA* being lower than the brake torque demands RQT_FA and RQT_RA. The higher threshold means that recuperation can be used until the threshold is reached, rather than switching to the fallback level immediately. In a further development, a corresponding signal of the central control electronics unit is also provided, which can indicate recuperation braking to the brake control units. As this signal can also be faulty, the threshold should therefore be provided accordingly.

The method can accordingly provide for actuating of the wheel brake modules in the fallback level if
actuating information of at least one FA or rear axle pedal sensor is available, but no brake torque demands RQT_FA* and RQT_RA* by the central control electronics unit exist, or if,
in the case of actuating information by the actuating unit being present, there is an error message from the central control electronics unit, or if,
in the case of actuating information by the actuating unit being present, there is no bus signal on the data line, or if
the brake torque demands RQT_FA* and RQT_RA* exceed a predefined offset from the corresponding brake torque demands RQT_FA and RQT_RA.

Accordingly, the method provides to load the wheel brakes in the fallback level with the brake torque demand RQT_FA or RQT_RA of the brake control units, if actuating information of at least one pedal sensor is available, but no brake torque demands RQT_FA* and RQT_RA* by the central control electronics unit exist. This can be the case, for example, if the central control electronics unit is disconnected from the power supply or if the data line between the central control electronics unit and the brake control unit is not working properly.

The fallback level can also be selected if there is an error message from the central control electronics unit, or if there is no bus signal on the data line when actuating information by the actuating unit is present.

The fallback level can also be selected if the brake torque demands RQT_FA* and RQT_RA* exceed a predefined offset from the corresponding brake torque demands RQT_FA and RQT_RA. This is to ensure, as already explained, that no “underbraking” takes place, i.e. if the brake torque demands specified by the central control electronics unit deviate from the brake torque demands of the brake control units by a value which is greater than the predefined value or threshold.

The method can further comprise at least one of the following steps:
transmitting the actuating information independently of one another from the FA pedal sensor to the FA brake control unit via the first brake request signal line and/or from the RA pedal sensor to the RA brake control unit via the second brake request signal line,
transmitting the actuating information in each case independently of each other via the FA and RA brake control unit by the data line to the at least one central control electronics unit,
transmitting the brake torque demands RQT_FA* and RQT_RA* independently of each other via the data lines to the FA and RA brake control units.

The transmission of the actuating information independently of each other from the pedal sensors via physically separate signal or data lines to the assigned brake control units enables a maximum of safety even in the fallback level, since, in the event of failure of one of the two control paths, the redundantly designed other control path has the same functions, with the result that the actuating information can be transmitted independently of each other to two different axles and the brake control units and wheel brakes which are assigned to them. In this way, it can be ensured that, even in the event of a failure of a component in the fallback level, the wheel brake modules at least of the unaffected axle of the motor vehicle still remain functional. This means that a prescribed minimum brake effect can be achieved, even if there is a functional impairment in the fallback level.

According to one configuration, therefore, the transmission of the actuating information is also provided in each case in an independent or physically separated manner via the respective FA and RA brake control unit by data lines to the at least one central control electronics unit.

The transmission of the brake torque demands RQT_FA* and RQT_RA* from the central control electronics unit may also be carried out here independently of each other via the data lines to the FA or RA brake control unit.

The generation of the brake torque demands RQT_FA* and RQT_RA* by the central control electronics unit can be carried out according to stored central control algorithms, wherein the central control algorithms can preferably comprise at least an anti-slip control operation or an anti-lock brake control operation.

According to a further embodiment, a further data bus is provided which can connect the central control electronics unit to a higher-level vehicle computer. In this way, further control parameters can be made available to the central control electronics unit, which can be used to generate the brake torque demands RQT_FA* and RQT_RA*.

This makes it possible, for example, to use the method even for or together with driverless driving, wherein, for example, brake specifications can then be transmitted via the higher-level vehicle computer to the central control electronics unit and from there to the brake control units. The generation of the brake torque demands RQT_FA* and RQT_RA* can therefore at least partly be based on signals which are transmitted to the central control electronics unit via the data bus.

A parking brake button can also be integrated into the brake system and can be connected to the data bus, for example. The method makes it possible in this way that actuating information of the parking brake button for actuating the wheel brake modules can also be taken into account when the central control electronics unit is actuated via the parking brake button.

In the fallback mode level, the wheel brakes can be actuated solely by the brake actuating unit without further communication via the data bus.

The axle-specific brake torque demands RQT_FA, RQT_RA can be generated by the brake control units according to stored local control algorithms, which can be stored in the brake control units. For cost reasons, for instance, the local control algorithms can have a reduced functional scope compared to the central control algorithms of the central control electronics unit, and can, for example, comprise only anti-slip control.

According to one development, it can also be provided for the central control electronics unit to be divided with two separate partitions which can each be assigned to an axle, that is to say, for example, an FA partition and an RA partition, and which can generate the brake torque demands independently of each other.

This enables the generation of the brake torque demands RQT_FA* by the FA partition and transmission via the data line to the FA brake control unit, as well as the generation of the brake torque demands RQT_RA* by the RA partition and transmission via the data line to the RA brake control unit. In this way, increased safety can be provided by redundancy even in the normal operating level.

The FA brake control unit and/or the RA brake control unit can each be connected to an FA axle controller or an rear axle axle controller in signal terms or else can be integrated into it. The axle controllers can be configured to generate wheel-specific brake commands RQT_xA*, RQT_xA from the brake torque demands and to transmit them to the individual wheel brake modules. An axle controller can also be present as a pure software solution and can be implemented, for instance, in the brake control unit.

According to a further embodiment, it can also be provided that the FA axle controller and/or the rear axle axle controller are/is designed as a control device close to the wheel, i.e. as a so-called WCU, with the result that, for example, two FA wheel controllers and/or two rear axle wheel controllers are provided which are directly assigned to the corresponding wheel brake modules. Here, the associated FA brake control unit and/or the RA brake control unit can also be divided and accordingly assigned to each vehicle wheel in a wheel-specific manner. It goes without saying that, in this case, the data lines can be of correspondingly split design.

As already explained, as an alternative or in addition to the axle-specific brake torque demands RQT_FA*, RQT_RA* or RQT_FA, RQT_RA, corresponding wheel-specific brake commands RQT_xA*, RQT_xA can also be generated and transmitted. This allows the wheel brakes to be directly actuated individually. It goes without saying that the brake control units can also be configured accordingly to compare the brake commands RQT_xA* of the central control electronics unit with the locally generated brake commands RQT_xA. The decision logic unit can be configured for the comparison in the same way as for the brake torque demands. Instead of the axle-specific brake torque demands, the wheel-specific brake commands RQT_xA* and the corresponding wheel-specific brake commands RQT_xA can thus be compared with each other.

According to one embodiment, it is provided that the transmission of a brake request in the form of the actuating information from the FA and rear axle pedal sensors to the central control electronics unit is conducted solely via the brake request signal line to the FA and rear axle brake control units and from there via the further data line. In other words, at least one pedal sensor, preferably both pedal sensors, is/are not directly connected to the central control electronics unit in signal terms. This reduces the complexity involved in installing the brake system.

In another embodiment, it is provided that a data line is routed directly from an FA or rear axle pedal sensor to the central control electronics unit instead of to the corresponding FA and rear axle brake control unit.

According to a further development of the invention, an additional data line between the FA and rear axle brake control units can also be provided, which enables data exchange between the FA and rear axle brake control units in the fallback operating level. This allows the brake control units to communicate with each other independently of the data connection to the central control electronics unit. In this way it is possible to improve the actuation of the wheel brakes, since information about the respective other axle is available.

In a further aspect, the invention comprises a brake system, in particular for a motor vehicle, wherein the brake system is designed for carrying out a method as explained above.

The brake system can comprise, in accordance with one embodiment of an architecture:
four electrically actuable wheel brake modules, each comprising a wheel brake,
at least one brake actuating unit, wherein the brake actuating unit has at least one FA pedal sensor and one rear axle pedal sensor, each of which is designed to detect actuating information, describing the brake demand, of the brake actuating unit independently of one another,
at least one first FA brake control unit which is assigned to the wheel brake modules of a front axle, and
at least one second rear axle brake control unit which is assigned to the wheel brake modules of a rear axle,
wherein the FA pedal sensor is connected at least to the FA brake control unit via at least one first brake request signal line,
wherein the rear axle pedal sensor is connected at least to the rear axle brake control unit via at least one second brake request signal line, and
at least one central control electronics unit which is connected via at least one data line to the FA brake control unit and via at least one data line to the rear axle brake control unit.

According to one preferred embodiment of the invention, at least one of the FA and rear axle pedal sensors, particularly preferably the two pedal sensors, is/are not directly connected to the central control electronics unit in signal terms in the case of the brake system. In this way, the installation into the motor vehicle can be simplified.

According to one preferred embodiment of the invention, the central control electronics unit comprises an FA partition and an RA partition, wherein the FA partition can be configured to generate a brake torque demand RQT_FA* independently of the RA partition and to transmit it via a data line to the FA brake control unit, and wherein the RA partition is configured to generate a brake torque demand RQT_RA* independently of the FA partition and to transmit it via the data line to the RA brake control unit.

The FA brake control unit and/or the RA brake control unit can each be connected to an FA axle controller or an RA axle controller in signal terms and/or can be integrated into it.

The central control electronics unit can be connected to a vehicle computer via at least one data bus.

According to a further preferred embodiment of the invention, a parking brake button can be provided which can be connected via a data line to the central control electronics unit. Here, the central control electronics unit can be configured to be able to be actuated by the parking brake button.

According to yet a further preferred embodiment of the invention, an additional signal line can be provided between the central control electronics unit and the FA brake control unit and/or the rear axle brake control unit. This signal line can also have an emergency stop switch.

According to a further preferred embodiment of the invention, the FA brake control unit and the rear axle brake control unit can each have two different power supplies or can each have different power supplies. In this way, it can be ensured that at least one brake control unit can still be supplied with power in the event of a power supply failure.

The same also applies according to yet a further preferred embodiment of the invention to the at least two pedal sensors, which can accordingly also have a different power supply.

### BRIEF DESCRIPTION OF THE DRAWINGS

Further details of the invention result from the description of the illustrated exemplary embodiments and the appended claims.

In the drawings:

FIG. 1 shows a schematic plan view of one example of an architecture of a brake system according to the invention for a motor vehicle,

FIG. 2 shows a further example of an architecture of a brake system according to the invention in a schematic plan view,

FIG. 3 shows yet a further example of an architecture of a brake system 10 according to the invention in a schematic plan view with an emergency stop switch,

FIG. 4 shows yet a further example of an architecture of a brake system 10 according to the invention in a schematic plan view, which has a lower redundancy,

FIG. 5 shows yet a further example of an architecture of a brake system 10 according to the invention in a schematic plan view, with a brake control unit of two-part design,

FIG. 6 shows yet a further example of an architecture of a brake system 10 according to the invention in a schematic plan view with an additional data line,

FIG. 7 shows the underlying method for operating the brake system according to the architecture of FIG. 1, schematically in a flow chart,

FIG. 8 shows the underlying method for operating the brake system according to the architecture of FIG. 2, schematically in a flow chart,

FIG. 9 shows the underlying method for operating the brake system according to the architecture of FIG. 4, schematically in a flow chart, and

FIG. 10 shows yet a further example of an architecture of a brake system 10 according to the invention with a hydraulic system in a schematic plan view with an additional data line.

### DETAILED DESCRIPTION

In the following detailed description of preferred embodiments, for the sake of clarity, the same reference signs designate substantially identical parts in or on these embodiments. However, for better clarification of the invention, the preferred embodiments illustrated in the figures are not always drawn to scale.

The invention relates to a method for operating a brake system 10, in particular for a motor vehicle 1, with four electrically actuable wheel brake modules 11, 12, 13, 14 which are assigned to two different axles 2, 3 of the motor vehicle 1, with the following steps:
determining actuating information describing a brake demand by a brake actuating unit 20, wherein preferably the brake demand can be detected by at least a first pedal sensor or FA pedal sensor 21 and a second pedal sensor or RA pedal sensor 22 independently of each other,
generating brake torque demands (RQT_FA*, RQT_RA*) corresponding to the actuating information by a central control electronics unit 70,
generating brake torque demands (RQT_FA) corresponding to the actuating information by at least one FA brake control unit 30 which is assigned to the wheel brake modules 11, 12 of a front axle 2, or which is assigned to two diagonally arranged wheel brake modules 11, 12, 13, 14,
generating brake torque demands (RQT_RA) corresponding to the actuating information by at least one RA brake control unit 40 which is assigned to the wheel brake modules 13, 14 of a rear axle 3, or which is assigned to the two other diagonally arranged wheel brake modules 11, 12, 13, 14,
actuating the wheel brake modules 11, 12, 13, 14 of the brake system 10 according to a normal operating level with the brake torque demand (RQT_FA*, RQT_RA*), or
actuating the wheel brake modules 11, 12, 13, 14 according to a fallback level with the brake torque demand (RQT_FA), and/or actuating the wheel brake modules 11, 12, 13, 14 according to the fallback level with the brake torque demand (RQT_RA).

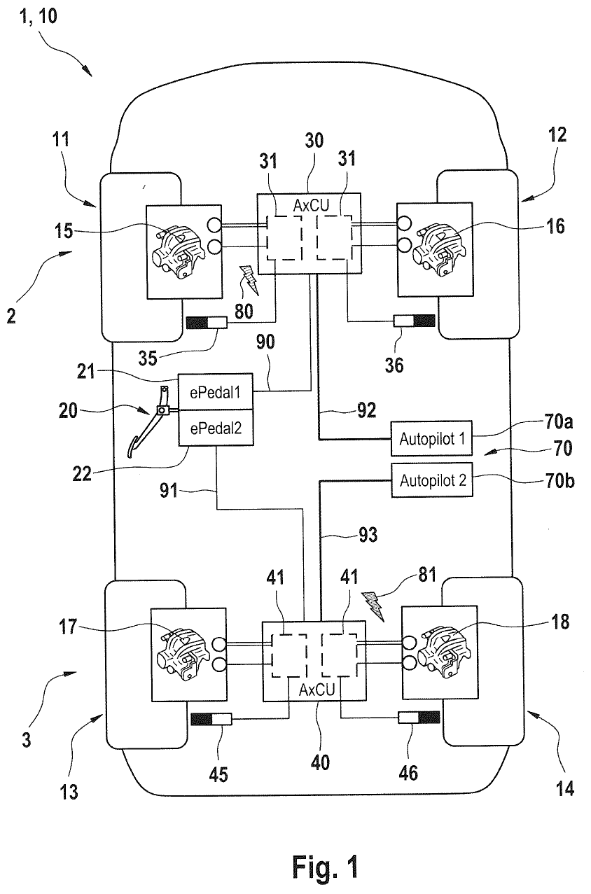

FIG. 1 shows a schematic plan view of one example of a possible architecture for a brake system 10, which is suitable for carrying out the abovementioned method.

In the example of FIG. 1, the wheel brake modules 11, 12, 13, 14 each comprise

electromechanical disk brakes as wheel brakes 15, 16, 17, 18. Alternatively, the wheel brakes can also be designed as electromechanical drum brakes. Combinations are also possible, even in conjunction with hydraulically actuable wheel brakes.

The method according to the invention provides that, in addition to the central control electronics unit 70 which allows operation of the brake system 10 in a normal operating level, a fallback level is provided which is divided into two parts.

To this end, the brake system 10 in the exemplary embodiment of FIG. 1 comprises a brake actuating unit 20 which is configured to detect a driver's brake request and to determine corresponding actuating information which corresponds to the brake demands of the driver.

Here, the actuating information is detected independently of each other by an FA pedal sensor 21 and an RA pedal sensor 22. These two pedal sensors 21, 22 are combined in the brake actuating unit 20.

The central control electronics unit 70 is configured to generate the brake torque demand based on the actuating information on the basis of stored control algorithms. The brake torque demand can be axle-specific, but also wheel-specific here.

The wheel brakes 15, 16, 17, 18 are each part of the wheel brake module 11, 12, 13, 14. In the example shown, the brake system 10 comprises in each case two wheel brake modules 11, 12 on the front axle 2 and two further wheel brake modules 13, 14 on the rear axle 3, which are each assigned to a vehicle wheel. The wheel brake modules 11, 12, 13, 14 can be electrically actuated.

The division in two according to the invention of the fallback level is achieved, inter alia, in that at least each axle 2, 3 of the motor vehicle 1 is each assigned a brake control unit 30, 40. As can be seen from FIG. 1, the front axle 2 is assigned a brake control unit (hereinafter referred to as FA brake control unit 30), and the rear axle is assigned a further brake control unit (hereinafter referred to as RA brake control unit 40).

The FA brake control unit 30 and the RA brake control unit 40 are configured to generate the brake torque demands RQT_FA, RQT_RA based on the actuating information of the brake actuating unit 20 on the basis of stored control algorithms.

Furthermore, two axle controllers 31, 41 are provided which are each assigned to an axle. These FA axle controllers 31 or RA axle controllers 41 are connected to the corresponding FA brake control unit 30 or RA brake control unit 40 in signal terms. The axle controllers 31, 41 are configured to generate wheel-specific brake commands RQT_xA*, RQT_xA from the brake torque demands and to transmit them to the individual wheel brake modules. In the example of FIG. 1, the respective brake control units and associated axle controllers are structurally combined in one module.

The two pedal sensors 21, 22 are connected to the brake control units 30, 40 electrically or in signal terms, with the result that actuating information can be transmitted to the brake control units 30, 40. The actuating information is transmitted here as digital signals.

Here, as shown in the example of FIG. 1, the FA pedal sensor 21 is connected to the FA brake control unit 30 via a brake request signal line 90, and the RA pedal sensor 22 is connected to the RA brake control unit 40 via a further brake request signal line 91. The actuating information can accordingly be detected independently of each other and transmitted independently of each other to the respective brake control units 30, 40.

The brake control units 30, 40 are still connected to the central control electronics unit 70 in signal terms. In this way, the actuating information from the pedal sensors 21, 22 can be transmitted via the brake control units 30, 40 to the central control electronics unit 70.

In the example of FIG. 1, a central control electronics unit 70 for the central generation of brake torque demands RQT_FA*, RQT_RA* and at least two brake control units 30, 40 each assigned to an axle 2, 3 of the motor vehicle 1 for the independent generation of brake torque demands RQT_FA, RQT_RA are accordingly provided. In this way, the fallback level can be designed in two parts and divided over the two axles 2, 3.

This enables the brake system 10 to switch back to two separate, independently operating control paths in the fallback level in the event of a lack of brake torque demands RQT_FA*, RQT_RA* of the central control electronics unit 70. In such a case, the brake demand of the driver detected at the brake pedal can lead to a brake torque demand RQT_FA for the vehicle wheels of the front axle 2 and its implementation at the assigned wheel brake modules 11, 12, and, independently of this, the separately detected brake demand leads to a brake torque request RQT_RA for the vehicle wheels of the rear axle 3 and its implementation at the assigned wheel brake modules 13, 14.

For the connection in signal terms between the pedal sensors 21, 22 and the brake control units 30, 40, the brake system 10 can comprise in each case two separate brake request signal lines 90, 91.

Slip control can take place on the two brake control units 30, 40 independently of each other.

In the exemplary embodiment of FIG. 1, furthermore, a data line 92 is provided between the central control electronics unit 70 and the FA brake control unit 30, and a further data line 93 is provided between the at least one central control electronics unit 70 and the RA brake control unit 40. For further increased operational safety, these data lines 92, 93 can also be of double, i.e. redundant, design.

In the exemplary embodiment of FIG. 1, wheel speed sensors 35, 36, 45, 46 are illustrated purely by way of example, which are each assigned to a vehicle wheel and are configured to measure the respective wheel speed during operation and to transmit it to the FA or RA brake control unit 30, 40 associated with the axle 2, 3.

In the exemplary embodiment of FIG. 1, the central control electronics unit 70 is formed with two separate partitions 70a, 70b which are each assigned to an axle 2, 3 and which are configured to generate the brake torque demands for the corresponding wheel brake modules 11, 12, 13, 14 of the respective axes 2, 3 independently of each other. The division into two partitions, as also shown below, is not mandatory for the invention and thus represents only one possible exemplary embodiment.

The partition 70a is connected in signal terms in FIG. 1 via the data line 92 to the FA brake control unit 30, and the partition 70b is connected via the data line 93 to the RA brake control unit 40.

In the exemplary embodiment of FIG. 1, the two brake control units 30, 40 are connected to two different power supplies 80, 81, with the result that, in the event of failure of a power supply 80, 81, at least one brake control unit 30, 40 of an axle 2, 3 also remains functional in the fallback level.

Here, the two partitions 70a, 70b can also each be equipped with or comprise (as indicated in FIG. 1) an autopilot function (“Auto 1”, “Auto 2”). These functions can be designed to independently generate the brake torque demands RQT_FA*, RQT_RA* for the wheel brakes of each axle 2, 3.

Due to the complete axle-related separation of the actuation, coupled functions which require a different coordinated actuation of the wheel brakes of different axles 2, 3 are not possible. Such brake systems 10 can therefore be used, for example, in slow-moving transport vehicles in which such a stability control can be dispensed with.

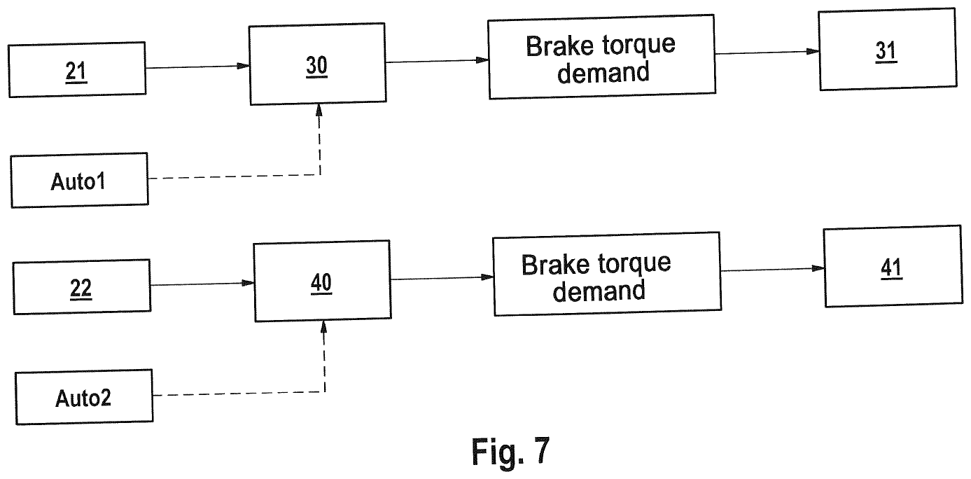

FIG. 7 shows schematically an overview of the sequence of the method for operating a brake system as shown in FIG. 1.

The example of FIG. 1 thus shows a very consistently divided, two-circuit brake system which can also already be operated in the normal operating level in the two-circuit state (“safe state”). Both the pedal sensors 21, 22 and the partitions 70a, 70b of the central control electronics unit 70 each independently operate an axle, and the two subsystems are independent of each other.

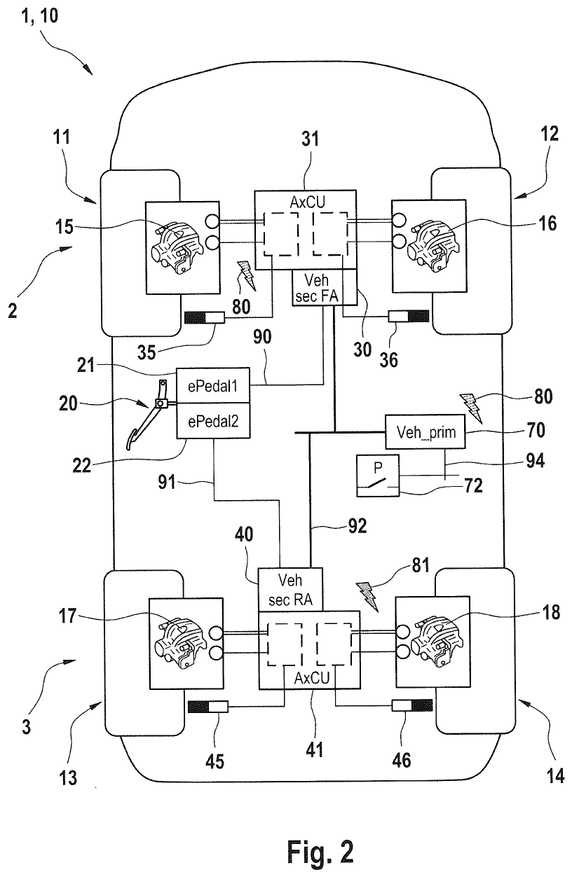

The architecture shown in FIG. 1 thus represents only one embodiment of a brake system according to the invention for a specific application area. On the other hand, the architecture of FIG. 2 shows one particularly preferred embodiment of the invention. FIG. 2 thus shows a particularly preferred example of an architecture of a brake system 10 according to the invention in a schematic plan view. In this exemplary embodiment, the central control electronics unit 70 is not divided into partitions and is also connected only via a single data line 92 to the FA and RA brake control units 30, 40, which can bring assembly and cost advantages. In addition, the central control electronics unit 70 is connected to a parking brake button 72 via a further data line 94 or a further data bus.

In the normal operating level, the central control electronics unit 70 operates the brake system 10 in a single circuit, and, in the fallback level, the two brake control units 30, 40 operate the brake system 10 in two circuits.

This data line 94 can also be used very favorably for a connection of the central control electronics unit 70 to a higher-level vehicle computer (not shown).

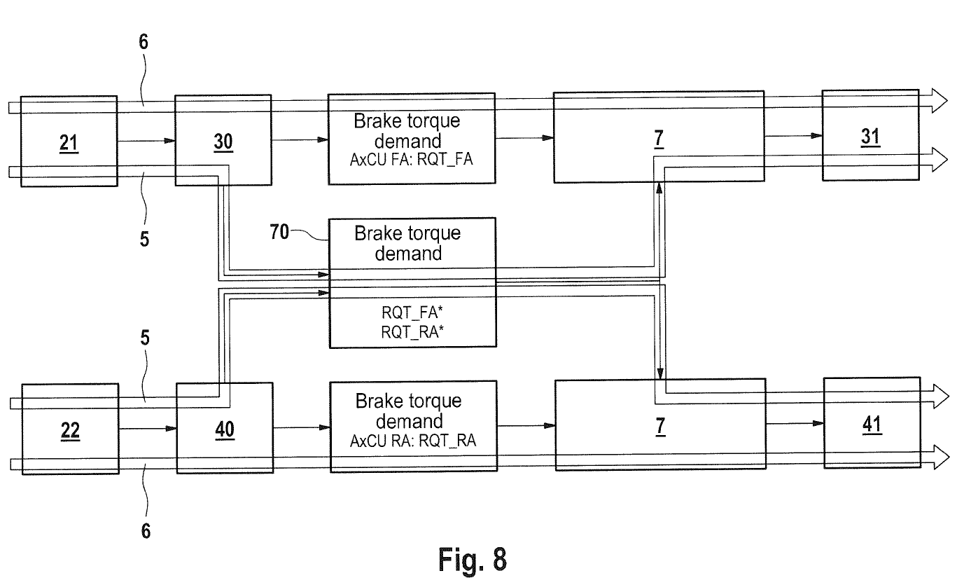

The method according to the invention provides for actuating of the wheel brake modules 11, 12, 13, 14 in a normal operating level and in a fallback level. The method of operating a brake system according to FIG. 2 is shown schematically in an overview in FIG. 8 and comprises two control paths, wherein a normal path 5 indicates the normal operating method and a control path 6 indicates the fallback level.

In the normal operating method, the actuation takes place based on the brake torque demands RQT_FA*, RQT_RA* of the central control electronics unit 70. By means of a decision logic unit which is labeled in FIG. 8 by the reference number 7, these brake torque demands RQT_FA*, RQT_RA* are compared with the brake torque demands RQT_FA, RQT_RA which are generated directly by the brake control units 30, 40.

The decision logic unit 7 is accordingly used to switch over between the normal operating level and the fallback level. The decision logic unit 7 is implemented in the brake control units (30, 40) by means of corresponding control algorithms.

If the brake torque demands RQT_FA, RQT_RA are higher by a predefined value or a threshold than the brake torque demands RQT_FA*, RQT_RA*, these brake torque demands RQT_FA, RQT_RA are used to actuate the wheel brake modules in the fallback level. Thus, the invention enables the realization of a “safety barrier”, i.e. a safety threshold. This threshold can be very high and e.g. brake torque corresponding to 0.5 g/1 g.

This also makes it possible to apply a retardation by recuperation without being overridden by the “safety barrier”.

In the normal operating method, the central control electronics unit 70 can arbitrate the normal brake function with other control functions, i.e. also form brake torque demands RQT_FA*, RQT_RA* from other functions and transmit them to the wheel brake modules 11, 12, 13, 14. Here, the individual wheel brakes 15, 16, 17, 18 can also be actuated individually.

In addition, dynamic braking can also be realized using the parking brake button 72.

When switching off of the central control electronics unit 70 is detected, which can be detected by the decision logic unit, a switchover is then carried out to the two FA and RA brake control units 30, 40, and the brake torque demands RQT_FA, RQT_RA directly formed in the FA and RA brake control units 30, 40 are used for the actuation of the wheel brake modules without a threshold according to the fallback level.

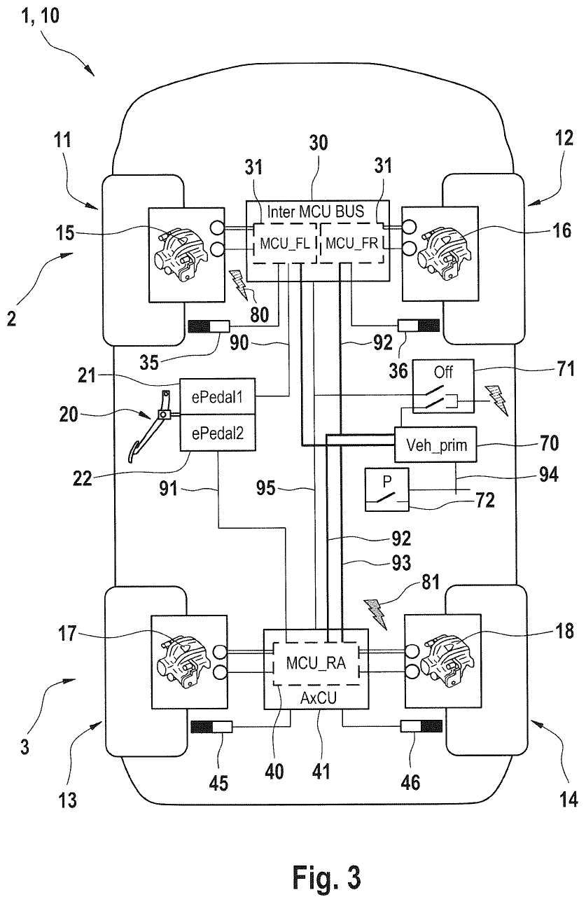

This can be detected by a missing bus signal on the corresponding data line 92, 93, or by an additional voltage level which is conducted from an emergency stop switch 71 to the FA and RA brake control units 30, 40 and interrupts this level when switching. There can also be an error message from the central control electronics unit 70, which can be detected. An emergency stop switch 71 can be integrated into the architecture, as shown in the example of FIG. 3.

In the case of the architecture as shown in FIG. 2 and FIG. 8, the control path 6 of the fallback level is of two-circuit and diverse design, with the result that, in the event of a failure of the signals of the central control electronics unit 70, the higher-order control functions are switched off, and the brake system falls back to a safe two-circuit basic brake with basic function and slip control.

The term “diverse” here means that the two fallback paths or circuits are different assemblies which

can comprise different hardware and software components, in order that a systematically caused simultaneous failure can be avoided.

The method for operating the brake system therefore provides for actuating of the wheel brake modules 11, 12, 13, 14 in the normal operating level if
brake torque demands (RQT_FA*, RQT_RA*) exist and actuating information of at least one FA and/or RA pedal sensor 21, 22 is available, and if
there is no error message from the central control electronics unit 70, and if
the brake torque demands (RQT_FA*, RQT_RA*) do not deviate from the corresponding brake torque demands (RQT_FA, RQT_RA) by a predefined value.

The method for operating the brake system 10 thus provides for actuating of the wheel brake modules 11, 12, 13, 14 in the fallback level if
actuating information of at least one FA or rear axle pedal sensor 21, 22 is available, but no brake torque demands (RQT_FA*, RQT_RA*) by the central control electronics unit 70 exist, or if,
in the case of actuating information by the actuating unit being present, there is an error message from the central control electronics unit 70, or if,
in the case of actuating information by the actuating unit being present, there is no bus signal on the data line 92, 93, or if
the brake torque demands (RQT_FA*, RQT_RA*) exceed a predefined offset from the corresponding brake torque demands (RQT_FA, RQT_RA).

FIG. 3 shows yet a further example of an architecture of a brake system 10 according to the invention in a schematic plan view. In this exemplary embodiment, the brake control unit 30, 40 is integrated into the respective axle controller 31, 41, and the two components are designed as one module.

In this exemplary embodiment, an emergency stop switch 71 is provided which is connected in signal terms via a signal line 95 to the FA and RA brake control units 30, 40.

Furthermore, the data lines 92, 93 between the central control electronics unit 70 and the FA and RA brake control units 30, 40 are of double, i.e. redundant, design, which further increases the failsafe performance.

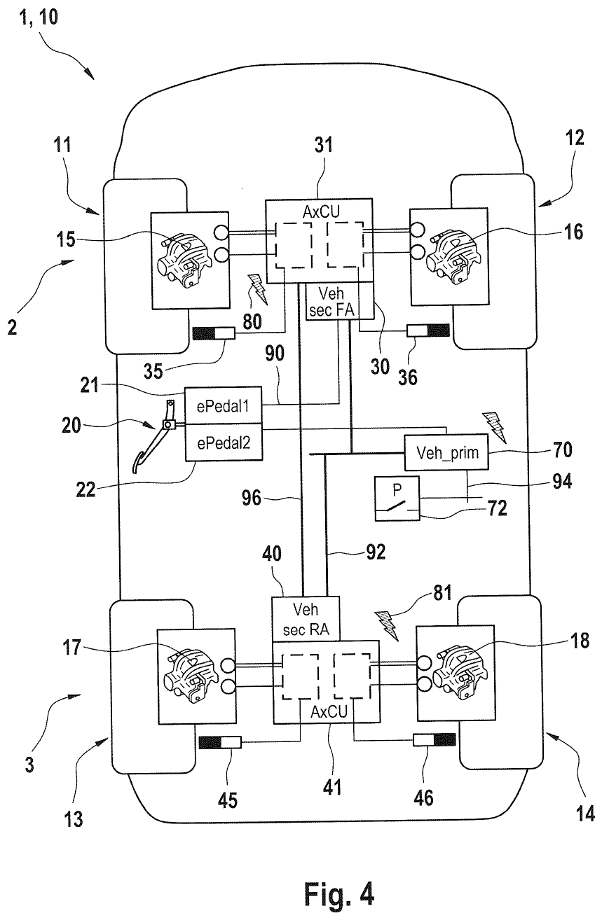

FIG. 4 shows yet a further example of an architecture of a brake system 10 according to the invention in a schematic plan view. In this exemplary embodiment, the second pedal sensor 22 is not connected to a brake control unit, but rather to the central control electronics unit 70. In addition, a data line 96 is provided between the FA brake control unit 30 and the RA brake control unit 40.

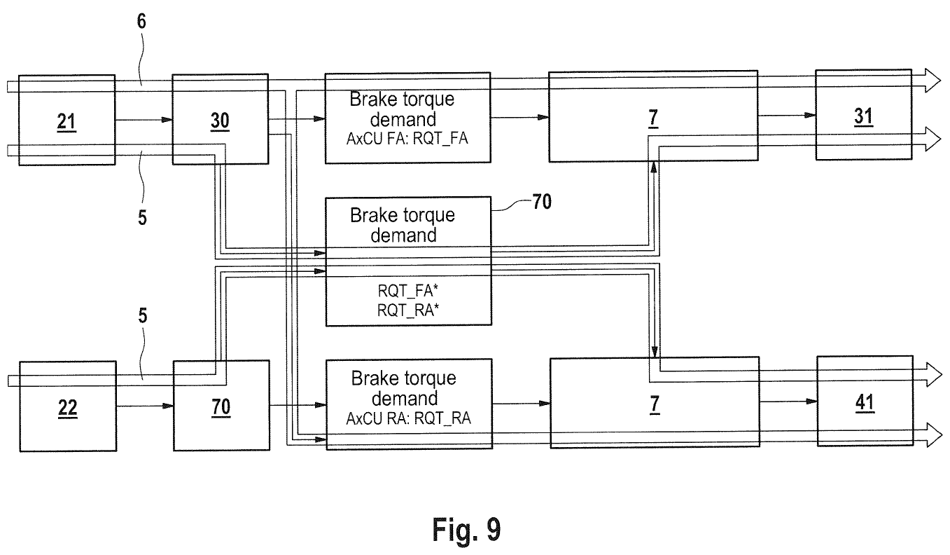

The method underlying this architecture for operating the brake system 10 is shown schematically in an overview in FIG. 9 and also comprises two control paths, wherein a normal path 5 indicates the normal operating method and a control path 6 indicates the fallback level. It can be seen that the normal path 5 of the normal operating method proceeds largely analogously to the above-outlined normal operating methods with the exception that a brake request signal line is routed directly from a pedal sensor to the central control electronics unit 70.

A “safety barrier” with a predefined value or threshold can also be stored, since the RA brake control unit 40 can firstly receive brake torque demands RQT_FA, RQT_RA from the FA brake control unit 30 via the data line 96 and brake torque demands RQT_FA*, RQT_RA* via the data line 92. Accordingly, the corresponding comparison can be made in an analogous manner by the decision logic unit 7 in the two brake control units 30, 40. However, there is a difference to the abovementioned architectures in the fallback level. The fallback level is no longer available in a completely redundant manner, since, in the example, the RA brake control unit 40 can be actuated only via the data line 96. Although all four wheel brakes 15, 16, 17, 18 can still be actuated, the fallback level would fail if there was an additional fault in the pedal sensor 21 assigned to the other axle. Therefore, this architecture represents a possible, but not a preferred embodiment of the invention.

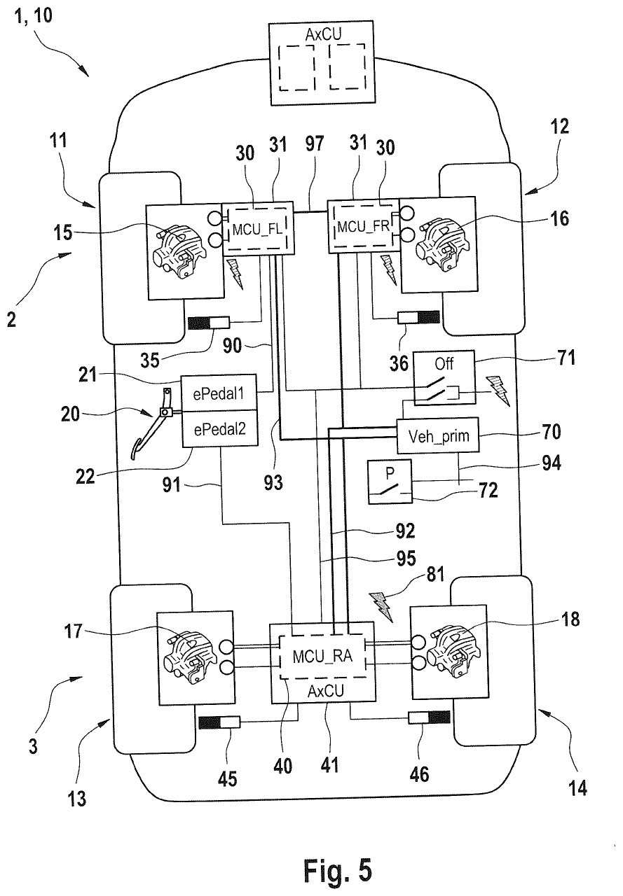

FIG. 5 shows yet a further example of an architecture of a brake system 10 according to the invention in a schematic plan view. In this exemplary embodiment, the FA brake control unit 30 and the associated axle controller 31 are designed in two parts and are each directly assigned to a wheel brake module 11, 12.

The associated data lines 92, 93 and 95 are of correspondingly split design. In addition, a further data line 97 is provided which enables a data exchange between the two FA brake control units 30. In this way, actuating information of the pedal sensor 21 can be transmitted to the two FA brake control units 30.

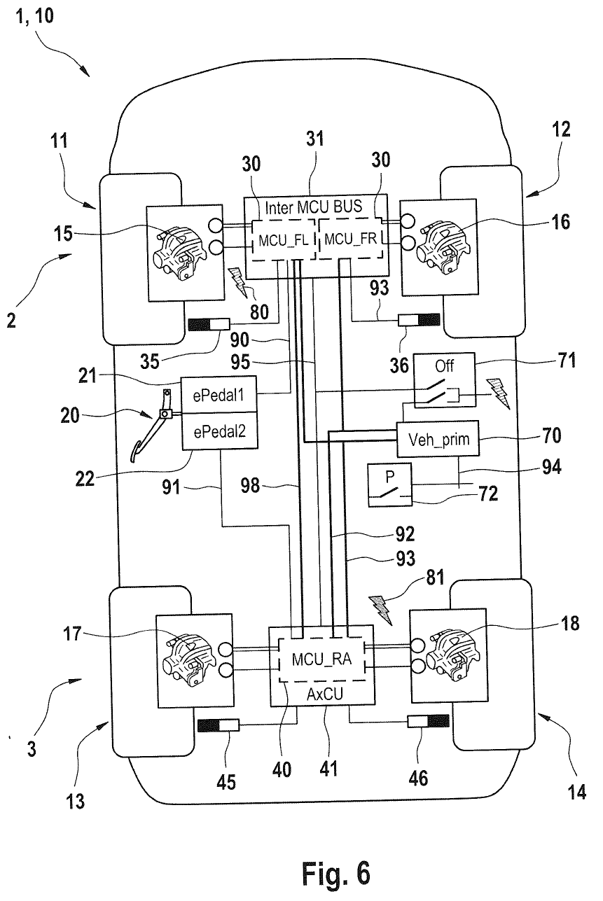

FIG. 6 shows yet a further example of an architecture of a brake system 10 according to the invention in a schematic plan view. In this exemplary embodiment, a further data line 98 is provided between the FA brake control units 30 and RA brake control units 40, with the result that direct communication is made possible.

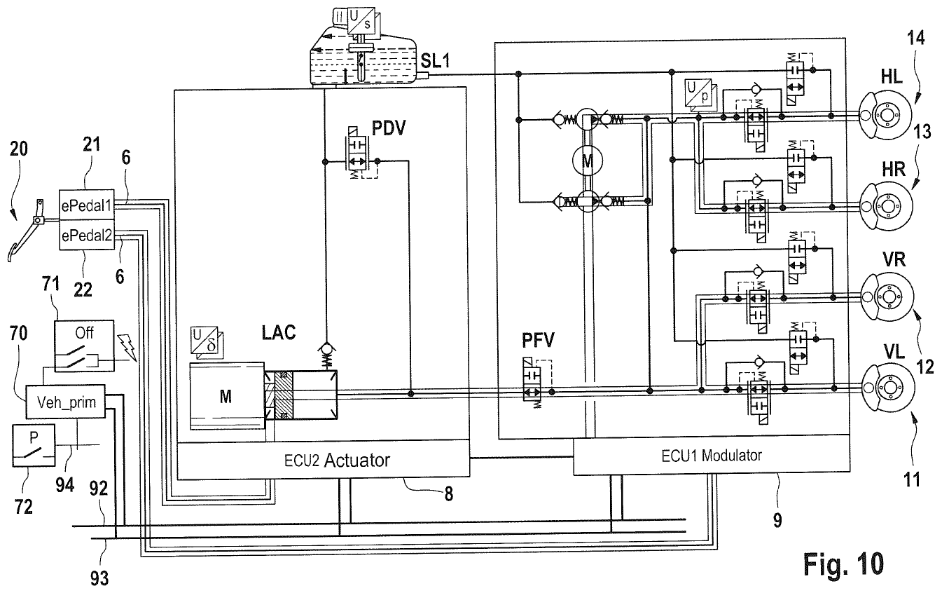

FIG. 10 shows yet a further example of an architecture of a brake system 10 according to the invention in a schematic plan view with a hydraulic system.

The normal operating method proceeds analogously to the exemplary embodiment shown in FIG. 6. The central control electronics unit 70 generates the brake torque demands RQT_FA*, RQT_RA* and transmits them to the brake control units.

The wheel brakes 11, 12, 13, 14 which in this case are hydraulically actuable are then actuated in a known manner in the normal operating method by the brake control units, to which end, inter alia, an actuator 8 and a modulator 9 are provided. In the fallback level which can be detected analogously by the decision logic unit 7, the brake system 10 then falls back to two separate control paths with the actuator 8 and the modulator 9, which then actuate the wheel brakes independently of the axle after the respective pedal sensor input.

Normal brake functions can be realized in the normal operating level, and a local, axle-related ABS can be realized in the fallback level.

1. A method for operating a brake system for a motor vehicle comprising:
determining actuating information describing a brake demand by a brake actuating unit, wherein the brake demand can be detected by at least one front axle pedal sensor and one rear axle pedal sensor independently of each other;
generating first font axle and rear axle brake torque demands corresponding to the actuating information with a central control electronics unit;
generating second front axle brake torque demands corresponding to the actuating information by at least one front axle brake control unit which is assigned to wheel brake modules of a front axle, or which is assigned to two diagonally arranged wheel brake modules,
generating second rear axle brake torque demands corresponding to the actuating information by at least one rear axle brake control unit which is assigned to wheel brake modules of a rear axle, or which is assigned to two other diagonally arranged wheel brake modules, and
actuating the wheel brake modules of the brake system according to one of:
a normal operating level with the first front axle and rear axle brake torque demands,
a fallback level with the second front axle brake torque demands front axle, and
a fallback level with the second rear axle brake torque demands.

2. The method for operating a brake system as claimed in claim 1, wherein the brake system further comprises:
at least one first brake request signal line between the front axle pedal sensor and the front axle brake control unit,
at least one second brake request signal line between the rear axle pedal sensor and the rear axle brake control unit,
at least one data line between the at least one central control electronics unit and the front axle brake control unit, and at least one data line between the at least one central control electronics unit and the rear axle brake control unit.

3. The method as claimed in further comprising:
switching between the normal operating level and the fallback level by a decision logic unit, wherein the decision logic unit integrated into one of the front axle and the rear axle brake control unit.

4. The method as claimed in claim 1 further comprising:
actuating the wheel brake modules in the normal operating level when
the first front axle and rear axle brake torque demands exist and actuating information of at least one front axle and rear axle pedal sensor is available,
there is no error message from the central control electronics unit, and
the first front axle and rear axle brake torque demands do not exceed a predefined offset from the corresponding second front axle and rear axle brake torque demands.

5. The method as claimed in claim 1 further comprising:
actuating the wheel brake modules in the fallback level when one of:
actuating information of at least one front axle or rear axle pedal sensor is available, but no first front axle or rear axle brake torque demands by the central control electronics unit exist,
in the case of actuating information by the actuating unit being present, there is an error message from the central control electronics unit,
in the case of actuating information by the actuating unit being present, there is no bus signal on at least data line,
the first front axle or rear axle brake torque demands exceed a predefined offset from the corresponding second front axle or rear axle brake torque demands.

6. The method as claimed in claim 1, further comprising at least one of:
transmitting the actuating information independently of one another from the front axle pedal sensor to the front axle brake control unit via a first brake request signal line and from the rear axle pedal sensor to the rear axle brake control unit via a second brake request signal line,
transmitting the actuating information in each case independently of each other via the front axle and rear axle brake control unit by at least one data line to the at least one central control electronics unit,
transmitting the first front axle or rear axle brake torque demands independently of each other via the at least one data line to the front axle and rear axle brake control units.

7. The method as claimed in claim 1, further comprising:
generating the first front axle or rear axle brake torque demands according to central control algorithms stored in the central control electronics unit.

8. The method as claimed in claim 1, wherein the central control electronics unit is connected via a data bus to a vehicle computer, and wherein the generation of the first front axle or rear axle brake torque demands is at least partially based on signals which are transmitted via the data bus to the central control electronics unit.

9. The method as claimed in claim 8, wherein the data bus is connected to a parking brake button, and wherein the central control electronics unit can be actuated via the parking brake button.

10. The method as claimed in claim 1, further comprising:
generating the brake torque demands according to stored local control algorithms by the brake control units.

11. The method as claimed in claim 1, wherein the central control electronics unit comprises an front axle partition and an rear axle partition which independently generate the first front axle or rear axle brake torque demands, further comprising:
generating the first front axle brake torque demands by the front axle partition and transmitting them via the data line to the front axle brake control unit,
generating the first rear axle brake torque demands by the rear axle partition and transmitting them via the data line to the rear axle brake control unit.

12. The method as claimed in claim 1, wherein at least one of the front axle brake control unit and the rear axle brake control unit is of split configuration and is each directly assigned to a wheel brake module.

13. The method as claimed in claim 1, further comprising:
transmitting the actuating information from the front axle and rear axle pedal sensors to the central control electronics unit solely via the first and second brake request signal line to the front axle and rear axle brake control units and from there via at least one data line.

14. The method as claimed in claim 1, wherein, in the fallback level, the actuating of the wheel brakes takes place solely by the brake actuating unit without further communication via a data bus.

15. The method as claimed in claim 1, wherein, furthermore, an additional data line is provided between the front axle and rear axle brake control unit, which enables data exchange between the front axle and the rear axle brake control unit.

16. A brake system for a motor vehicle comprising:
a plurality of front axle brake wheel brake modules;
a plurality of rear axle wheel brake modules;
a brake actuating unit for determining actuating information describing a brake demand, wherein the brake demand can be detected by at least one front axle pedal sensor and one rear axle pedal sensor independently of each other;
an central control unit with instructions for generating first front axle and rear axle brake torque demands corresponding to the actuating information;
at least one front axle brake control unit with instructions for generating second front axle brake torque demands corresponding to the actuating information by which is assigned to wheel brake modules of a front axle, or which is assigned to two diagonally arranged wheel brake modules,
at least one rear axle brake control unit with instructions for generating second rear axle brake torque demands corresponding to the actuating information by which is assigned to wheel brake modules of a rear axle, or which is assigned to two other diagonally arranged wheel brake modules, and
wherein the brake actuation unit actuates the plurality of front axle and rear axle wheel brake modules of the brake system according to one of:
a normal operating level with the first front axle and rear axle brake torque demands,
a fallback level with the second front axle brake torque demands front axle, and
a fallback level with the second rear axle brake torque demands.

17. The brake system as claimed in claim 16,
wherein the plurality of front axle and rear axle wheel brake modules, each comprise a wheel brake,
wherein the brake actuating unit has at least one front axle pedal sensor and one rear axle pedal sensor, each of which is designed to detect actuating information, describing the brake demand, of the brake actuating unit independently of one another,
wherein the front axle pedal sensor is connected at least to the front axle brake control unit, via at least one first brake request signal line,
wherein the rear axle pedal sensor is connected at least to the rear axle brake control unit via at least one second brake request signal line, and
wherein the at least one central control electronics unit is connected via at least one data line to the front axle brake control unit and via at least one data line to the rear axle brake control unit.

18. The brake system as claimed in claim 16, wherein the central control electronics unit comprises a front axle partition and a rear axle partition, and wherein the front axle partition is configured to generate a first front axle brake torque demand of the first brake torque demands independently of the rear axle partition and to transmit the first front axle demand via the at least one data line to the front axle brake control unit, and wherein the rear axle partition is configured to generate a first rear axle brake torque demand of the first brake torque demands independently of the front axle partition and to transmit it via another of the at least one data line to the rear axle brake control unit.

19. The brake system as claimed in claim 16, wherein the at least one date line comprises a further data line provided between the central control electronics unit and a higher-level vehicle computer, and wherein the central control electronics unit is configured to be able to be actuated by the vehicle computer.

20. The brake system as claimed in claim 19, wherein a parking brake button is connected via the further data line to the central control electronics unit, and wherein the central control electronics unit is configured to be able to be actuated by the parking brake button.

21. The brake system as claimed in claim 16, wherein an additional signal line is provided between the central control electronics unit and at least one of the front axle brake control unit and the rear axle brake control unit, and wherein the signal line is connected to an emergency stop switch.

22. The brake system as claimed in one of the preceding claim 16, wherein the front axle brake control unit and the rear axle brake control unit each have two different power supplies.
